(19) United States
(12) Patent Application Publication
(10) Pub. No.: US 2004/0151974 A1
(43) Pub. Date: Aug. 5, 2004

(54) PEM fuel cell with flow-field having a branched midsection

(76) Inventors: Jeffrey Allan Rock, Fairport, NY (US); Pinkhas A. Rapaport, Fairport, NY (US)

Correspondence Address: CARY W. BROOKS, General Motors Corporation, Legal Staff, Mail Code 482-C23-B21, P.O. Box 300, Detroit, MI, 48265-3000, US

(21) Appl. No.: 10/664,504

(22) Filed: Sep. 17, 2003

Related U.S. Application Data
(63) Continuation-in-part of application No. 10/356,672, filed on Jan. 31, 2003.

(51) Int. Cl. H01M 8/02; H01M 8/10

(52) U.S. Cl. 429/38; 429/30

(57) ABSTRACT

A current-collecting plate of a PEM fuel cell has a reaction gas flow-field comprising a plurality of flow-channels each having an inlet leg communicating with a fuel supply manifold, an exit leg communicating with a fuel exhaust manifold, and a branched midsection intermediate the inlet and exit legs.

This is a continuation in part of United States Patent Application U.S. Ser. No. 10/356,672 (now abandoned) filed Jan. 31, 2003 in the name of Jeffrey Rock, and assigned to the assignee of this application.

### TECHNICAL FIELD

This invention relates to PEM fuel cells and more particularly to the reactant flow-fields therefore.

### BACKGROUND OF THE INVENTION

Fuel cells have been proposed as a power source for many applications. One such fuel cell is the PEM (i.e., proton exchange membrane) fuel cell. PEM fuel cells are well known in the art and include in each cell thereof a so-called “membrane-electrode-assembly” (hereafter MEA) comprising a thin (i.e., ca. 0.0015-0.007 inch), proton-conductive, polymeric, membrane-electrolyte having an anode electrode film (i.e., ca. 0.002 inch) formed on one face thereof, and a cathode electrode film (i.e., ca. 0.002 inch) formed on the opposite face thereof. Such membrane-electrolytes are well known in the art and are described in such U.S. patents as U.S. Pat. Nos. 5,272,017 and 3,134,697, as well as in the Journal of Power Sources, Volume 29 (1990) pages 367-387, inter alia. In general, such membrane-electrolytes are made from ion-exchange resins, and typically comprise a perfluoronated sulfonic acid polymer such as NAFION™ available from the E.I. DuPont de Nemours & Co. The anode and cathode films, on the other hand, typically comprise (1) finely divided carbon particles, very finely divided catalytic particles supported on the internal and external surfaces of the carbon particles, and proton conductive material (e.g., NAFION™) intermingled with the catalytic and carbon particles, or (2) catalytic particles, sans carbon, dispersed throughout a polytetrafluoroethylene (PTFE) binder. One such MEA and fuel cell is described in U.S. Pat. No. 5,272,017 issued Dec. 21, 1993, and assigned to the assignee of the present invention.

The MEA is sandwiched between sheets of porous, gas-permeable, conductive material, known as a “diffusion layer”, which press against the anode and cathode faces of the MEA and serve as (1) the primary current collectors for the anode and cathode, and (2) mechanical support for the MEA. Suitable such primary current collector sheets comprise carbon or graphite paper or cloth, fine mesh noble metal screen, and the like, through which the gas can diffuse, or be driven, to contact the MEA underlying the lands, as is well known in the art.

The thusly formed sandwich is pressed between a pair of electrically conductive plates which serve as secondary current collectors for collecting the current from the primary current collectors, and for conducting current between adjacent cells internally of the stack (i.e., in the case of bipolar plates), and externally of the stack (i.e. in the case of monopolar plates at the ends of the stack). The secondary current collecting plates each contain at least one active region including a so-called “flow-field” that distributes the fuel cell's gaseous reactants (e.g., H₂ or O₂/air) over the surfaces of the anode and cathode. The flow-field includes a plurality of lands which engage the primary current collector and define therebetween a plurality of grooves or flow-channels through which the gaseous reactants flow between a supply manifold in a header region of the plate at one end of the channel and an exhaust manifold in a header region of the plate at the other end of the channel.

The pressure differentials (1) between the supply manifold and the exhaust manifold, and (2) between adjacent flow channels or segments of the same flow channel are, of considerable importance in designing a fuel cell. Serpentine channels have been used to achieve desired manifold-to-manifold pressure differentials as well as inter-channel pressure differentials. Serpentine flow-channels have an odd number of legs extending, in switchback style, between the supply and exhaust manifolds of the stack. Serpentine flow channels use various widths, depths and lengths to vary the pressure differentials between the supply and exhaust manifolds, and may be designed to drive some reactant gas trans-land between adjacent flow-channels, or between adjacent segments of the same flow-channel, via the current collecting diffusion layer in order to expose the MEA confronting the land separating the legs to reactant. For example, some gas can flow from an upstream leg of a flow-channel (i.e. where pressure is higher) to a parallel, downstream leg of the same flow-channel (i.e. where the pressure is lower) by moving through the diffusion layer engaging the land that separates the upstream leg from the parallel downstream leg. Non-serpentine flow-channels have been proposed that extend more or less directly between the supply and exhaust manifolds, i.e. without any hairpin/switchback-type turns therein, and hence in shorter lengths than the serpentine flow-channels.

Flow-field designers seek to provide the active region of the secondary current collector with a multiplicity of flow channels for distributing the fuel/oxidant gas uniformly over the active region. Heretofore, the number of flow-channels that could be provided in the active region of the plate was limited by the header space available for the H₂ and O₂ manifolds. In this regard, the portions of the headers available for forming each of the H₂ and O₂ manifolds was relatively small (e.g. <ca. ½ the total header space available to all the manifolds) which resulted in crowding of the flow channels in the vicinity of the supply and exhaust manifolds (i.e. near where the where the flow channels and the manifolds meet). Fewer flow-channels results in higher manifold-to-manifold pressure drops and requires more energy to pump the reactant gases through the flow field.

### SUMMARY OF THE INVENTION

The present invention is directed to a PEM fuel cell flow-field having flow-channels with branched midsections adjoined to inlet and exit legs that communicate with the supply and exhaust manifolds, whereby lower manifold-to-manifold pressure drops are possible. Moreover, branched flow-channels provide alternative routes for the reactive gas to flow within a single flow-channel if one of the branches of a flow-channel becomes plugged with water. More specifically, the present invention contemplates a PEM fuel cell having a gas-permeable, electrically conductive current collector engaging at least one face of a MEA, and a current-collecting plate engaging the gas-permeable current collector, and defining a gas flow-field that confronts the gas-permeable current collector. The flow-field comprises a plurality of lands that engage the gas-permeable current collector, and define a plurality of gas flow-channels, each of which has (a) an inlet leg communicating with a gaseous reactant supply manifold, (b) an exit leg communicating with a gaseous reactant exhaust manifold, and (c) a branched midsection between the inlet and exit legs that comprises at least first and second branches each having a first end communicating with the inlet leg and a second end communicating with the exit leg. The flow-channels may be serpentine or non-serpentine, and may have as many as three branches confronting the cathode side of the MEA, and as many five branches confronting the anode side of the MEA.

### BRIEF DESCRIPTION OF THE DRAWINGS

The invention will be better understood when considered in the light of the following detailed description of certain specific embodiments thereof which is given hereafter in conjunction with the several figures in which:

FIG. 1 is a schematic, exploded, isometric, illustration of a PEM fuel cell stack (only two cells shown);

FIG. 2 is an isometric, exploded, view of an MEA and bipolar plate of a PEM fuel cell stack;

FIG. 3 is a plan view of the bipolar plate of FIG. 2; and

FIG. 4 is a plan view of another embodiment of the invention.

### DESCRIPTION OF CERTAIN EMBODIMENTS

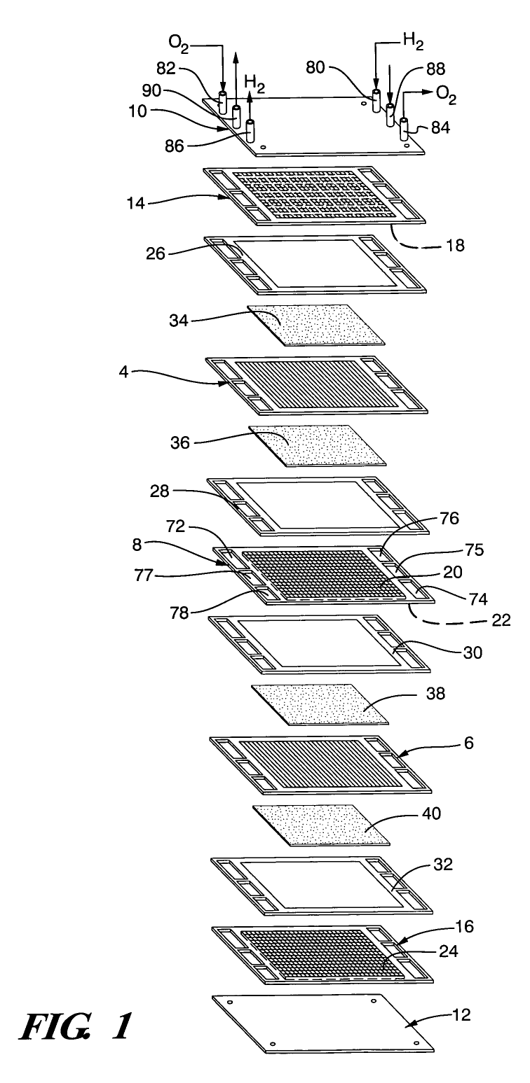

For simplicity, only a two-cell stack (i.e. one bipolar plate) is illustrated and described hereafter, it being understood that a typical stack will have many more such cells and bipolar plates. FIG. 1 depicts a two-cell, bipolar PEM fuel cell stack having a pair of membrane-electrode-assemblies (MEA's) 4 and 6 separated from each other by an electrically conductive, liquid-cooled, bipolar plate 8. The MEA's 4 and 6, and bipolar plate 8, are stacked together between stainless steel clamping plates 10 and 12, and monopolar end plates 14 and 16. The clamping plates 10, 12 are electrically insulated from the end plates 14, 16 by a gasket or dielectric coating (not shown). The monopolar end plates 14 and 16, as well as both working faces of the bipolar plate 8, contain a plurality of grooves or channels 18, 20, 22, and 24 defining a so-called “flow field” for distributing fuel and oxidant gases (i.e., H₂ & O₂) over the faces of the MEA's 4 and 6. Nonconductive gaskets 26, 28, 30, and 32 provide seals and electrical insulation between the several components of the fuel cell stack. Gas-permeable carbon/graphite diffusion papers 34, 36, 38 and 40 press up against the electrode faces of the MEA's 4 and 6. The end plates 14 and 16 press up against the carbon/graphite papers 34 and 40 respectively, while the bipolar plate 8 presses up against the carbon/graphite paper 36 on the anode face of MEA 4, and against carbon/graphite paper 38 on the cathode face of MEA 6.

The bipolar plates 8 may comprise graphite, graphite-filled polymer, or metal. Preferably, the bipolar plates will comprise two separate metal sheets/panels bonded together so as to provide a coolant flow passage therebetween. Bonding may, for example, be accomplished by brazing, diffusion bonding, or gluing with a conductive adhesive, as is well known in the art.

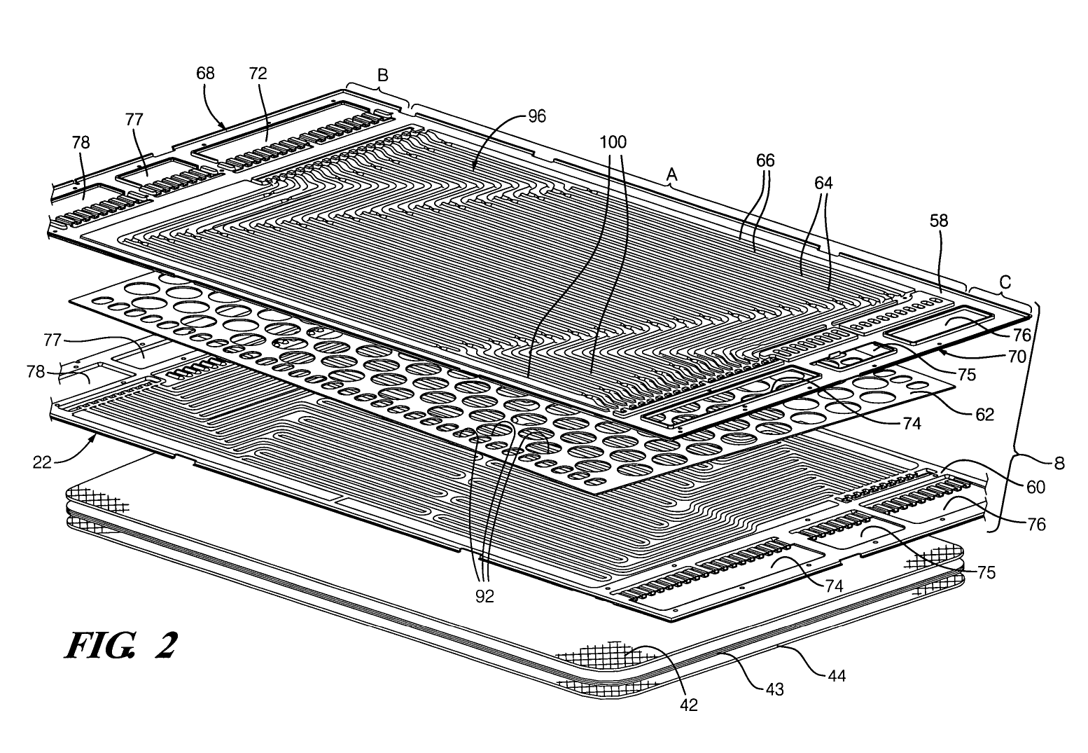

FIG. 2 is an isometric, exploded view of a bipolar plate 8, first primary porous current collector 42, MEA 43 and second primary porous current collector 44 as they are stacked together in a fuel cell. A second bipolar plate (not shown) would underlie the second primary current collector 44 to form one complete cell. Similarly, another set of primary current collectors and MEA (not shown) will overlie the upper sheet 58. The bipolar plate 8 comprises a first exterior metal sheet 58, a second exterior metal sheet 60, and an optional, perforated, interior metal sheet 62 which is brazed interjacent the first metal sheet 58 and the second metal sheet 60. The metal sheets 58, 60 and 62 are made as thin as possible (e.g. about 0.002-0.02 inches thick), and may be formed by stamping, by photo etching (i.e. through a photolithographic mask) or any other conventional process for shaping sheet metal. The external sheet 58 is formed so as to provide a reactant gas flow-field characterized by a plurality of lands 64 which define therebetween a plurality of non-serpentine gas flow-channels 66 through which one of the fuel cell's reactant gases (i.e. O₂ from air) flows from near one end 68 of the bipolar plate to near the opposite end 70 thereof. When the fuel cell is fully assembled, the lands 64 press against the primary current collectors lying above it (not shown) which, in turn, presses against the MEA with which it is associated (not shown). In operation, current flows from the primary current collector through the lands 64, and thence through the stack. The O₂ gas is supplied to flow-channels 66 from a header or supply manifold formed by aligned openings 72 in the several plates, gaskets, etc., and exits the channels 66 via an exhaust manifold formed by aligned openings 74 in the several plates, gaskets, etc. H₂ is supplied to the flow-channels on the underside of plate 60 from a header or supply manifold formed by aligned openings 76 in the several plates, gaskets, etc., and exhausted through an exhaust manifold formed by aligned openings 78 in the several plates, gaskets, etc. Coolant passes between the sheets 58 and 60 from an inlet manifold formed by aligned openings 75 in the several plates, gaskets, etc. to an outlet manifold formed by openings 77 in the several plates, gaskets, etc. In this regard, the bipolar plate 8 (e.g. see FIG. 2) has a central active region “A” that engages the primary current collector, and is bordered by inactive header regions “B” and “C”. The active region A has a working face having a cathode flow-field comprising a plurality of flow-channels 66 for distributing O₂/air over the face of the MEA 43 that it confronts. A similar working face 22 on the opposite (i.e. anode) side (not shown) of the bipolar plate 8 serves to distribute H₂ over the face of the MEA 6 that it confronts. The active region A of the bipolar plate 8 is flanked by two inactive header regions B and C that contain the several openings 72, 74, 75, 76, 77 and 78 there through. When the plates are stacked together, the openings in one bipolar plate are aligned with like openings in the other bipolar plates. Other components of the stack such as gaskets 26, 28, 30 and 32, as well as the membrane of the MEA's 4 and 6 and the end plates 14, 16 have corresponding openings (see FIG. 1) that align with the openings 72, 74, 75, 76, 77 and 78 in the bipolar plates in the stack, and together therewith form the aforesaid manifolds for supplying and exhausting gaseous reactants and liquid coolant to/from the stack. Referring to FIG. 1, oxygen/air is supplied to the air supply manifold 72 of the stack via appropriate O₂ supply plumbing 82, while hydrogen is supplied to the hydrogen supply manifold 76 via H₂ supply plumbing 80. Exhaust plumbing for both the H₂ (86) and O₂/air (84) are also provided for the H₂ and air exhaust manifolds. Additional plumbing 88 and 90 is provided for respectively supplying liquid coolant to, and removing coolant from, the coolant inlet 75 and outlet 77 manifolds.

Metal sheet 60 is similar to sheet 58. Like sheet 58, the underside of the sheet 60 has a working face 22 that engages the first current collector 42. The optional, perforated, interior, metal sheet 62 may be used interjacent the exterior sheets 58 and 60, and includes a plurality of apertures 92 that cause turbulent flow of the coolant for more effective heat exchange with the exterior sheets 58 and 60 respectively.

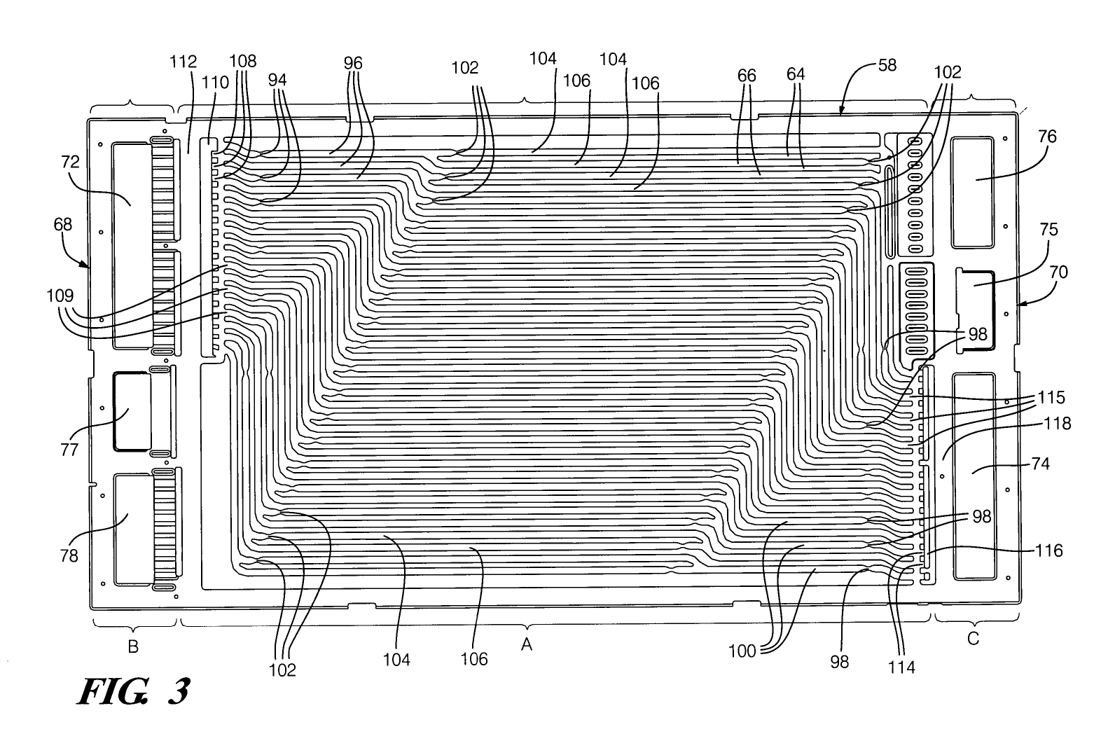

FIG. 3 is a plan view of plate 58 and more clearly shows bifurcated, non-serpentine flow-channels in accordance with one embodiment of the present invention. Each flow channel has an inlet leg 96 communicating with the O₂ supply manifold 72, an exit leg 100 communicating with the O₂ exhaust manifold 74, and medial legs/branches 104 and 106, in the midsections of the flow-channels, that communicate with the inlet and exit legs 96 and 100. The inlet legs 96 communicate with the supply manifold 72 via a plurality of openings 108 and a slot 110 that communicates with the manifold 72 via a passageway (not shown) that underlies section 112 of the plate 58. Similarly, the exit legs 100 communicate with the exhaust manifold 74 via a plurality of openings 114 which in turn communicate with the exhaust manifold 74 via a slot 116 that communicates with the manifold 74 via a passageway (not shown) that underlies section 118 of the plate 58. Several flow-restrictors 94, 98, and 102 (e.g. constrictions in the flow-channels) are strategically positioned/located in the several inlet (96), exit (100) and medial (104) legs of the bifurcated flow-channels 66, as needed, to achieve desired pressure differentials therein. Flow-restrictors are described in more detail in copending United States Patent Application U.S. Ser. No. ______ (Attorney Docket GP-301429), which is filed concurrently herewith, and intended to be incorporated herein by reference.

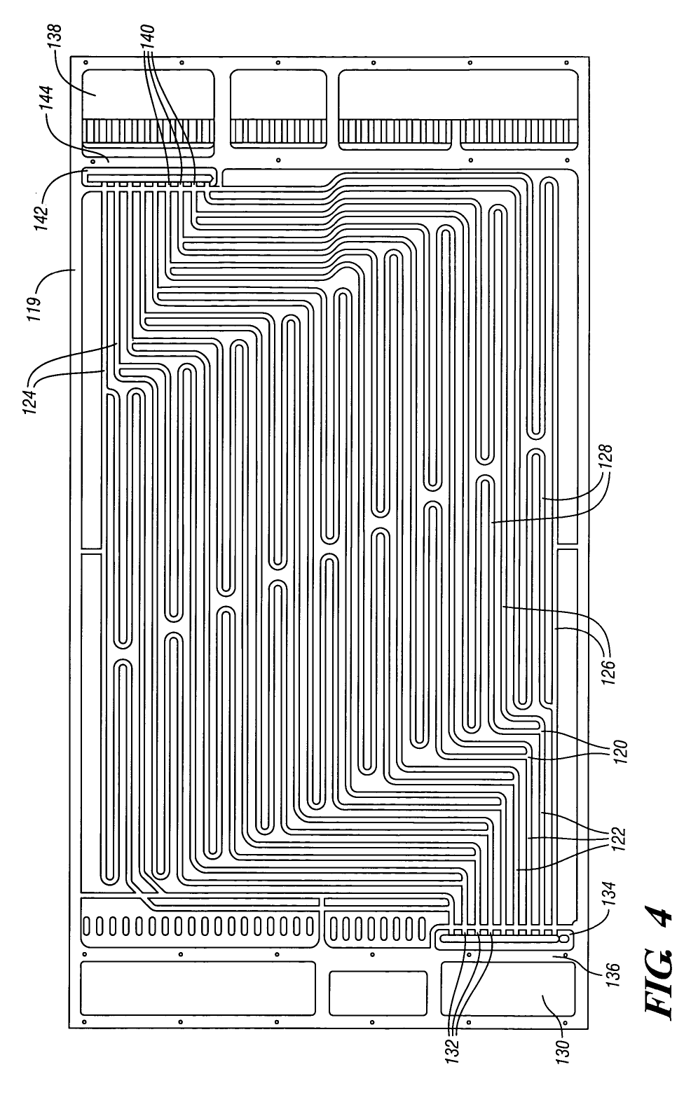

FIG. 4 is a plan view of another embodiment of the invention that shows a current collecting plate 119 having bifurcated serpentine flow-channels 120 each having an inlet leg 122, an exit leg 124 and a bifurcated midsection comprising a first branch 126, and a second branch 128. The inlet legs 122 communicate with a H₂ supply manifold 130 via a plurality of openings 132 and a slot 134 that communicates with the manifold 130 via a passageway (not shown) that underlies section 136 of the plate 119. Similarly, the exit legs 124 communicate with a H₂ exhaust manifold 138 via a plurality of openings 140 and a slot 142 that communicates with the exhaust manifold 138 via a passageway (not shown) that underlies section 144 of the plate 119.

While the invention has been described above in the context of bifurcated flow-channels having only two branches, it is not limited thereto. Rather, up to five branches (i.e. pentafurcated) are useful with flow-channels for H₂, and up to three branches (i.e. trifurcated) are useful for flow-channels for air. In this regard, the inlet and outlet legs must pass all of the gas that flows through the several branches of the flow channels. Too many branches results in too much pressure drop in the inlet and outlet legs.

While the invention has been described in terms of certain specific embodiments thereof it is not intended to be limited thereto, but rather only to the extent set forth hereafter in the claims which follow.

1. A PEM fuel cell comprising (1) a proton exchange membrane having opposing cathode and anode faces on opposite sides of said membrane, (2) a gas-permeable, electrically-conductive current collector engaging at least one of said faces, (3) a current-collecting plate engaging said gas-permeable current collector and defining a gas flow-field confronting said gas-permeable current collector, said flow-field comprising a plurality of lands engaging said gas-permeable current collector and defining a plurality of gas flow-channels, each of said flow-channels having (a) an inlet leg communicating with a supply manifold that supplies a reactant gas to all said flow-channels, (b) an exit leg communicating with an exhaust manifold that receives said reactant gas from all of said flow-channels, and (c) a branched midsection between said legs comprising first and second branches each having a first end communicating with said inlet leg and a second end communicating with said exit leg.

2. A PEM fuel cell according to claim 1 wherein said flow-channels are non-serpentine.

3. A PEM fuel cell according to claim 1 wherein said flow-channels are serpentine.

4. A PEM fuel cell according to claim 1 wherein said midsection is bifurcated.

5. A PEM fuel cell according to claim 1 wherein said flow-field is adapted to supply H₂ to the anode face of said membrane, and said branched midsection comprises up to five said branches.

6. A PEM fuel cell according to claim 1 wherein said flow-field is adapted to supply air to the cathode face of said membrane, and said branched midsection comprises up to three said branches
